(19) United States
(12) Patent Application Publication
(10) Pub. No.: US 2009/0146916 A1
(43) Pub. Date: Jun. 11, 2009

(54) Display Intented to be Mounted on a Pair of Spectacles

(75) Inventors: Renaud Moliton, Charenton-le-Pont (FR); Cécile Bonafos, Paris (FR)

Correspondence Address: SOFER & HAROUN LLP., 317 MADISON AVENUE, SUITE 910, NEW YORK, NY, 10017, US

(73) Assignee: ESSILOR INTERNATIONAL (COMPAGNIE GÉNÉRALE D'OPTIQU, Charenton-le-pont (FR)

(21) Appl. No.: 12/085,051

(22) PCT Filed: Dec. 1, 2006
(86) PCT No.: PCT/FR2006/051269

§ 371 Date: May 14, 2008

(30) Foreign Application Priority Data
Dec. 13, 2005 (FR) 05 53845

(51) Int. Cl. G09G 5/00

(52) U.S. Cl. 345/8

(57) ABSTRACT

The invention relates to a display (1) for mounting on a pair of eyeglasses (2), the display comprising an electronic and optical system (20A) for generating light beams, and an imager (20B) for shaping the light beams therefrom, the display including a removable connection arrangement for connection to the pair of eyeglasses and an adjustment arrangement for adjusting the position of said imager relative to the eye of the wearer. According to the invention, the display comprises two elements, a first element (10) carrying said removable connection arrangement, and a second element (20) comprising said electronic and optical system and said imager and connectable to said first element by means of said adjustment arrangement that includes means for locking in the adjusted position, said adjustment arrangement serving to adjust the position of said imager relative to the eye of the wearer both horizontally and vertically.

The invention relates to a display for mounting on a pair of eyeglasses.

Such an ophthalmic display comprises an optical imager that enables information of the image or multimedia type to be projected. The optical imager is designed to shape light beams coming from an electronic and optical system for generating light beams from an electronic signal, the system being of the miniature screen, laser diode, or light-emitting diode (LED) type, for example. The optical imager directs the light beams towards the eye of the wearer to enable the information content thereof to be viewed.

Such a display can be used for viewing the multimedia content coming from a mobile telephone, a digital player, a personal computer, a games console, or any other device enabling multimedia content to be delivered.

The term display is used herein to mean an assembly constituted by the optical imager and the electronic and optical system for generating light beams. The conventional elements of a pair of eyeglasses are known as the frame and as the ophthalmic lenses carried by the frame.

The term “eyeglass frame” is used herein also to cover optical equipment such as masks used for diving, skiing, or safety reasons.

U.S. Pat. No. 6,204,974 discloses fastening a display on an eyeglass frame.

In a first variant, the display is clipped to the frame and more precisely to one of the branches or “temples” of the frame.

That type of fastening thus comprises an arrangement for releasably connecting the display to the frame, enabling the display to be secured to the wearer's pair of eyeglasses when the wearer desires to make use thereof, and enabling it to be separated therefrom when the wearer so desires, in which case the wearer uses the pair of eyeglasses in conventional manner.

Nevertheless, that type of fastening does not make any provision for adjusting the imager to the characteristics of the wearer, such as the distance between the pupils (pupillary distance), where making such an adjustment serves to enable the wearer to see a complete image, i.e. an image not having any portion that is hidden by a vignetting phenomenon.

In a second variant, the display includes an imager hinged to the associated electronic and optical system for generating light beams. That type of display can also be clipped onto a branch of a frame.

Although that type of display provides not only a releasable connection arrangement for the display on the frame, but also enables the position of the imager to be adjusted as a function of the characteristics of the wearer by means of its hinge, it nevertheless raises the following problems.

Once it has been secured to the frame, the imager can be positioned correctly relative to the wearer's eye by moving the hinge. If it is subsequently removed, that non-rigid assembly is most unlikely to remain in the same position. In other words, the relative position of the imager and of the electronic and optical system for generating light beams will be modified, so it needs to be adjusted again each time it is connected.

Furthermore, that hinged assembly is relatively bulky, which is not practical after it has been separated and needs to be stored, e.g. in the pocket of a garment, and which is unattractive in appearance when it is connected to an eyeglass frame.

The invention solves these problems by a display that can be secured to the pair of eyeglasses while allowing the position of the imager relative to the wearer's eye to be adjusted, once and for ever, by the wearer, said adjustment being conserved whenever the display is subsequently separated from the frame. The display in accordance with the invention can also be particularly compact.

Patent document DE 102 31 427 describes a display for mounting on a pair of eyeglasses, the display comprising a system for generating light beams and an imager for shaping the light beams coming therefrom. That display includes a releasable connection arrangement for connecting it on the pair of eyeglasses and an arrangement for adjusting the position of the imager relative to the wearer's eye. That connection arrangement may comprise two elements, a first element constituting a support element and a second element constituting a position adjustment and angle adjustment element that is provided on the support element.

Nevertheless, that document does not specify how the second element is made.

The invention solves these problems, and to do so it provides a display for mounting on a pair of eyeglasses, the display comprising an electronic and optical generator system for generating light beams and an imager for shaping the light beams therefrom, the display including an arrangement for releasably securing it on the pair of eyeglasses and an arrangement for adjusting the position of said imager relative to the eye of the wearer, the display comprising two elements, a first element carrying said releasable connection arrangement and a second element comprising said electronic and optical system and said imager, by said adjustment arrangement including means for locking in an adjusted position, said adjustment arrangement enabling the position of said imager relative to the wearer's eye to be adjusted both horizontally and vertically, said light beams being defined by a so-called “main” ray, said main ray being the light ray coming from the center of a miniature screen of said light beam generator system and propagating to strike the pupil of the eye in its center, the display being characterized in that said adjustment arrangement comprises a shaft capable of turning in said second element and secured to said imager, said shaft being capable of turning about an axis belonging to the plane containing the path of said main ray and perpendicular to said main ray in the portion of its path extending between the pupil of the eye and the last optical surface of said imager through which said ray passes.

The display in accordance with the invention can be designed to be small and lightweight. It is thus easy to handle, to carry about, and to keep in a garment pocket. In addition, because of its light weight, it does not deform the frame by stressing it.

The display in accordance with the invention can be situated close to the lens of the pair of eyeglasses, by means of a connection system that is compact. It therefore does not upset the balance of the eyeglass frame.

In a preferred embodiment, said second element has a protective cover, with only the imager lying outside the cover.

The display in accordance with the invention is thus protected against impacts that might damage it.

Preferably, said adjustment arrangement comprises a rail and slide arrangement.

Advantageously, said rail is carried by said first element and said slide is carried by said second element.

Said slide may be substantially parallel to the longitudinal axis of the imager.

Advantageously, said shaft is also secured to said optical light beam generator system and is disposed close thereto.

Alternatively, the shaft may be capable of turning about an axis lying in the vertical plane of symmetry of the virtual image and perpendicular to said main ray in the portion of its path that extends between the pupil of the eye and the last optical surface of the imager through which the ray passes.

Preferably, said axis of rotation intersects said main ray inside the imager.

Advantageously, said locking means is constituted by a thrust element carried by said second element and designed to push a locking jaw.

Preferably, said jaw comes into abutment against said rail of said first element, when said first element is in place in said slide, and said screw is tightened.

Said jaw may be caused to press against said shaft under drive from said screw.

Preferably, said jaw is constituted by a pad formed by a section of one of the profiled edges of said slide and movable towards the longitudinal axis of said slide, and by an extension of circularly arcuate shape surrounding part of said shaft and having its free end in abutment against a part that is stationary in the direction of said movement of said pad.

Said releasable connection arrangement may be constituted by a clip-fastener arrangement.

Said connection arrangement may include a deformable tongue provided with a locking catch.

Said connection arrangement may include two engagement slopes associated with two guide fins.

The invention also provides a frame for a pair of eyeglasses, the frame being designed to receive a display as specified above, and being characterized in that it includes a cavity designed to receive said first element engaged therein.

When the display is separated from the frame, the frame presents an appearance that is similar to a traditional eyeglass frame.

The invention is described in greater detail with the help of figures that merely show a preferred embodiment of the invention.

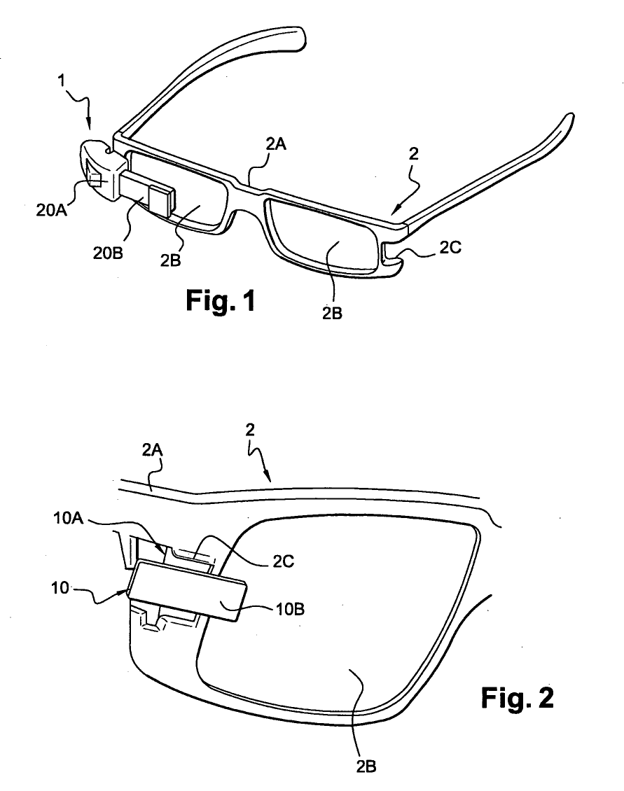

FIG. 1 is a diagrammatic perspective view of a pair of eyeglasses fitted with a display in accordance with the invention.

FIG. 2 is a diagrammatic perspective view of a pair of eyeglasses fitted with a portion of a display in accordance with the invention.

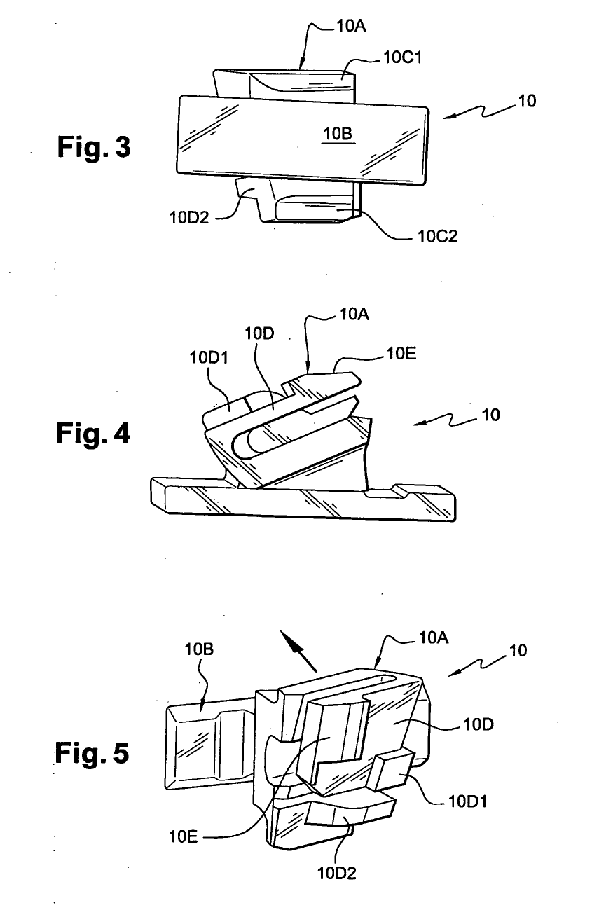

FIGS. 3 to 5 are fragmentary perspective views of a display in a preferred embodiment of the invention, seen from in front, from above, and from behind.

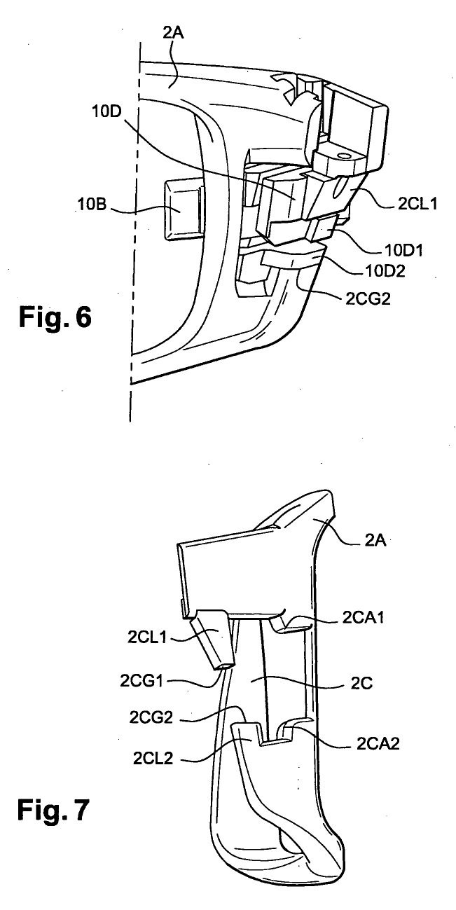

FIG. 6 is a fragmentary perspective view of a pair of eyeglasses fitted with a display in this preferred embodiment of the invention.

FIG. 7 is a fragmentary perspective view of a pair of eyeglasses for being fitted with a display in this preferred embodiment of the invention.

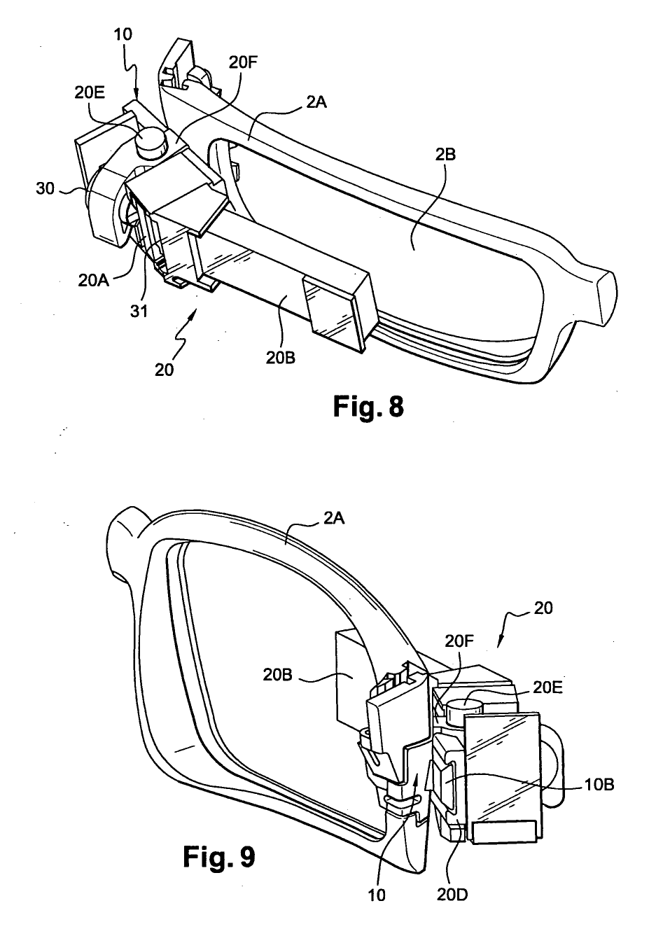

FIGS. 8 and 9 are perspective views of a display in a preferred embodiment of the invention.

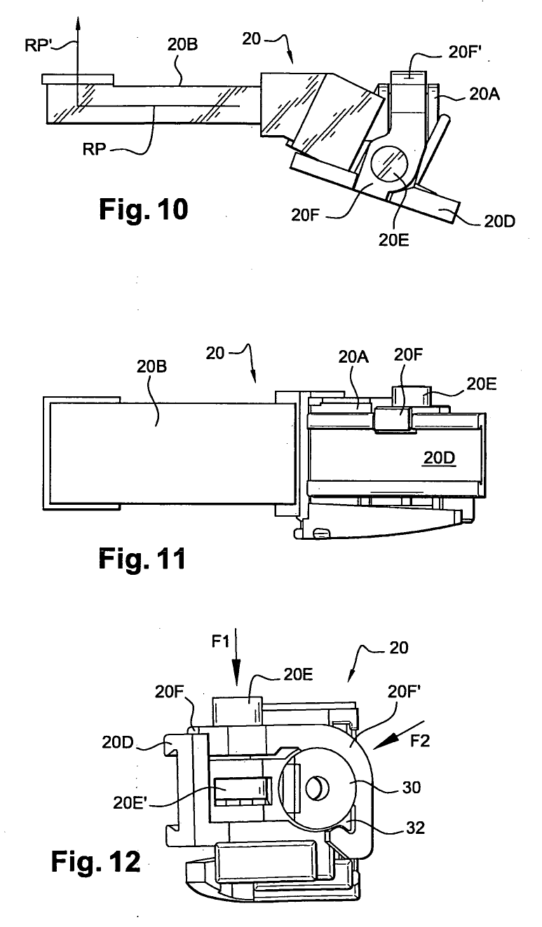

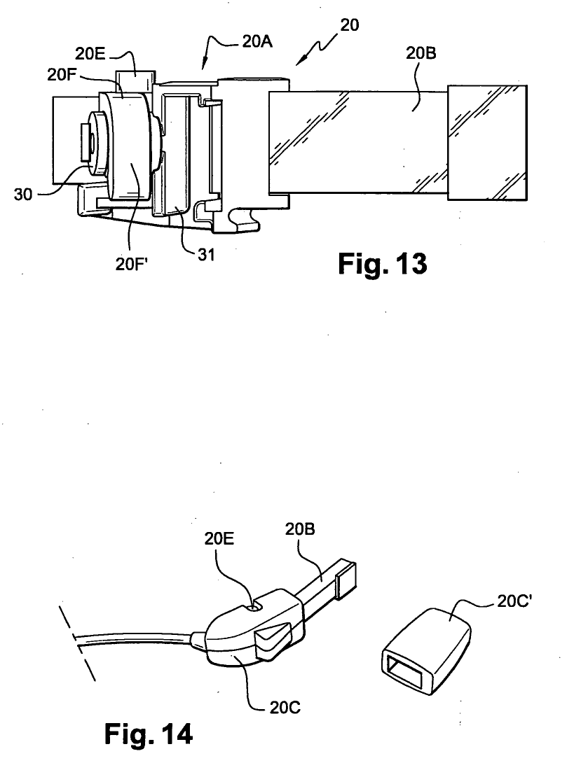

FIGS. 10 to 13 are views from above, from behind, from the side, and from in front of a display in this preferred embodiment of the invention.

FIG. 14 is a fragmentary perspective view of a display in a preferred embodiment of the invention.

FIG. 1 shows a display 1 mounted on a pair of eyeglasses 2 comprising a frame 2A and two ophthalmic lenses 2B.

The display 1 comprises an electronic and optical generator system 20A for generating light beams and an imager 20B for shaping the light beams coming from the generator system.

The display includes a releasable connection arrangement on the pair of eyeglasses 2 and an arrangement for adjusting the relative position between the imager 20B and the eye of the wearer. It comprises two elements, a first element 10 carrying the releasable connection arrangement, and a second element 20 comprising the electronic and optical system 20A and the imager 20B and connectable to the first element 10 via the adjustment arrangement that includes means for locking it in position.

As shown in FIG. 2, the first element 10 is formed by an engagement portion 10A designed to be received in a cavity 2C arranged in the frame 2A of the pair of eyeglasses. In this specific embodiment as shown, the cavity is arranged on one of the side uprights of the frame 2.

The releasable connection arrangement of the display is constituted by a clip-fastener arrangement carried by the first element 10.

The first element 10 also includes a rail 10B projecting from the front face of the pair of eyeglasses 2 when the first element 10 is mounted thereon.

Advantageously, the rail 10B is substantially parallel to the mean plane of the rim of the frame in which the lens 2B is mounted.

FIGS. 3 to 7 show a preferred embodiment of the first element 10 and of the frame 2A of the pair of eyeglasses that is to be fitted therewith.

The first element 10 shows in FIGS. 3 to 5 thus comprises the rail 10B and the engagement portion 10A that is designed in particularly ergonomic manner so as to enable engagement and disengagement to be performed easily and quickly by the wearer, while providing reliable retention.

The cavity 2C arranged in the frame 2A of the pair of eyeglasses is designed specifically to receive the first element 10 as shown.

This cavity 2C has two bearing zones, a top zone 2CA1 and a bottom zone 2CA2 that are for bearing on corresponding portions of the first element 10. It also has two rear bearing tongues, a top tongue 2CL1 and a bottom tongue 2CL2, for retaining the first element 10. Finally, it includes two insertion guide edges, a top edge 2CG1 and a bottom edge 2CG2 for enabling the first element 10 to be inserted along the two bearing tongues 2CL1 and 2CL2.

The first element 10 has corresponding portions designed to co-operate with these arrangements of the cavity 2C.

It has two engagement slopes, a top slope 10C1 and a bottom slope 10C2, for bearing against the bearing zones 2CA1 and 2CA2 of the cavity 2C. It also has two guide fins, a top fin 10D1 and a bottom fin 10D2, for preventing any tilting during insertion of the first element 10 in the cavity 2C, or during any removal therefrom. Finally, it includes a deformable tongue 10D provided with a catch 10E for locking the first element 10 in position in the cavity 2C.

The first element 10 is engaged in the cavity 2C to reach the engaged position shown in FIG. 6 by pushing the deformable tongue 10D in the direction of the arrow shown in FIG. 5 and by engaging the first element 10 in the cavity 2C. In order to ensure that engagement is quick and easy, the lengths of the guide fins 10D1 and 10D2 are particularly critical. It is ensured that these guide fins come into contact with their corresponding guide edges when the tongue 10D is still deformed little, so as to ensure that the first element 10 does not tilt during insertion under the effect of the return force due to deforming the deformable tongue 10D. Thus, the first element 10 is made easier to handle by the user, who then merely needs to press thereon to cause it to enter into position in the corresponding cavity 2C in the frame of the pair of eyeglasses. The purpose of this shape for the first element is to enable the user to put it into place merely by applying thrust.

By means of these improvements, once the first element 10 has been snap-fastened in the cavity 2C of the frame, it is held very firmly in place and the second element 20 can be put into place and adjusted on said element without difficulty and without losing adjustment.

The second element 20 can be seen in FIGS. 8 to 14, and in its mounted position on the first element 10 in FIGS. 8 and 9.

The second element 20 comprises the electrical and optical system 20A and the imager 20B, and it presents a protective cover 20C, with only the imager 20B lying outside the cover in the operating position. Advantageously, and as can be seen in FIG. 14, it may include a cap 20C′ that enables the imager 20B to be enclosed and protected in a transport or storage position.

In the example shown, the imager 20B has its longitudinal axis extending substantially horizontally in the mounted position, and it is disposed close to the lens 2B of a pair of eyeglasses.

The second element 20 carries a slide 20D that is substantially parallel to the longitudinal axis of the imager 20B. By means of this slide 20D that is for receiving the rail 10B, the second element 20 is connectable to the first element 10 by means of this rail-and-slide adjustment arrangement that also includes means for locking in position. The locking means is constituted by a screw 20E carried by the second element 20 for the purpose of pushing a locking jaw 20F that comes into abutment against the rail 10B of the first element, when said rail is in place in the slide 20D.

The jaw 20F clamped against the rail 10B thus locks the second element 20 on the first element 10 once the relative position of the second element 20 on the first element 10 corresponding to the desired relative position between the imager 20B and the eye of the wearer has been adjusted horizontally.

The adjustment arrangement of the invention enables the position of the imager to be adjusted relative to the eye of the wearer, both horizontally and vertically.

For vertical adjustment, the adjustment arrangement also includes a shaft 30 capable of turning in the second element 20 and to which the imager 20B is secured. Most advantageously, the shaft 30 is also secured to the optical system for generating light beams and is disposed close thereto.

The light beams are defined by a so-called “main” ray RP that is shown in FIG. 10, this main ray being the light ray coming from the center of the miniature screen 31 of the light beam generator system and propagating so as to strike the pupil of the eye in its center, this shaft 30 being cable of turning about an axis lying in the plane containing the path of the main ray and perpendicular to said main ray in the portion of its path RP′ extending between the pupil of the eye and the last optical surface of the imager 20B through said ray passes. In addition, and preferably, said axis of rotation intersects the main ray inside the imager 20B.

Thus, the position of the image delivered by the display is adjusted to the position of the wearer's eye by turning the imager 20B and the parts that are secured thereto, such as the miniature screen 31, about said axis.

This embodiment ensures maximum compactness by having the means for turning of the entire optical system positioned along said axis, behind the miniature screen, and as close as possible thereto.

The means for locking the adjustment arrangement are constituted by a thrust element, e.g. a screw 20E carried by the second element 20 and designed to push against a locking jaw 20F. In the example shown, the screw 20E passes through the jaw 20F and is screwed into a nut 20E′ that is held securely in a stationary part 32 forming a cradle for the shaft 30.

The jaw 20F can be seen particularly well in FIG. 12.

It is constituted by a pad 20F formed by a section of one of the shaped edges of the slide 20D and movable towards its longitudinal axis, and by an extension 20F′ of circularly arcuate shape surrounding part of the shaft 30 and having its free end in abutment in the direction of said displacement of the pad 20F against the stationary part 32 acting as the cradle for the shaft 30.

Tightening the single screw 20E in the direction represented by arrow F1 causes the pad 20F to come into abutment against the rail 10B of the first element when the first element is in place in said slide 20D, and locks it in position. Simultaneously, the circularly arcuate portion 20F′ of the jaw presses against the shaft 30 in the direction of arrow F2, still under thrust from the screw, and locks it in position.

On the first occasion that the wearer fits the frame of the eyeglasses 2 with a display in accordance with the invention, the first element 10 is clipped into a cavity 2C of the frame, as shown in FIG. 2.

The second element 20 is then connected to the first element 10 by putting the slide 20D into place on the rail 10B of the first element, as shown in FIG. 1.

The position of the imager 20B relative to the eye of the wearer can then be adjusted by relative positioning of the rail in the slide and by turning the imager about the axis of rotation 30. The optimum position is locked by tightening the screw 20E that is accessible from outside the cover 20C of the second element. It is also possible to adjust the position of the imager as a function of the distance between the wearer's pupils, and also as a function of the vertical position of the image relative to the wearer's eye.

When the wearer no longer wishes to use the display, the first element 10 is separated from the second element secured thereto. The frame of the pair of eyeglasses 2 then presents a pleasing appearance as shown on the right in FIG. 1. The display 1 is a compact rigid part that can be stored without problems of size or of losing adjustment.

During subsequent uses of the display, it suffices for the wearer to clip the display 1 in the corresponding cavity 2C of the frame of the pair of eyeglasses 2. No subsequent adjustment is needed for the same wearer.

The amplitude of the movement in translation desired for the connection between the rail 10B and the slide 20D is determined directly as a function of the range of half-pupil distances that it is desired to accommodate. Typically, about 97% of the population has a pupil distance lying in the range 56 millimeters (mm) to 72 mm, which leads to a pupil half-distance lying in the range 28 mm to 36 mm. If a mean value for the adjustment stroke in translation centered on a value of 32 mm is adopted, then a stroke of plus or minus 4 mm suffices for accommodating 97% of the population.

The amplitude of turning desired for the desired vertical adjustment depends essentially on the size of the eyebox of the optical system, and also on the accuracy of the chain of dimensions going from the wearer and passing via the frame to the display. The greater the eyebox, the smaller the adjustment needed in rotation for the vertical position. For example, if an amplitude of rotation is used that corresponds to a displacement of the eye over plus or minus 1 mm, that corresponds to an angle α where:

α=a tan(amplitude/Dv)

where Dv is the lens to eye distance, which is typically about 15 mm.

Thus, to obtain this amplitude, it suffices to provide the ability to turn through plus or minus 4°.

Marking can be provided on the ophthalmic lens or on the rail in order to assist in and facilitate adjusting the position of the imager relative to the wearer's eye.

The invention is not limited to the embodiment described above.

In addition, the display can be secured to a lens of a pair of eyeglasses instead of being secured to the frame thereof.

1. A display for mounting on a pair of eyeglasses, the display comprising:
an electronic and optical generator system for generating light beams and an imager for shaping the light beams therefrom, the display including an arrangement for releasably securing it on the pair of eyeglasses and an arrangement for adjusting the position of said imager relative to the eye of the wearer, the display having two elements, a first element carrying said releasable connection arrangement and a second element having said electronic and optical system and said imager, by said adjustment arrangement including means for locking in an adjusted position, said adjustment arrangement enabling the position of said imager relative to the wearer's eye to be adjusted both horizontally and vertically, said light beams being defined by a so-called “main” ray, said main ray being the light ray coming from the center of a miniature screen of said light beam generator system and propagating to strike the pupil of the eye in its center, wherein said adjustment arrangement comprises a shaft capable of turning in said second element and secured to said imager, said shaft being capable of turning about an axis belonging to the plane containing the path of said main ray and perpendicular to said main ray in the portion of its path extending between the pupil of the eye and the last optical surface of said imager through which said ray passes.

2. A display according to claim 1, wherein said second element has a protective cover, with only the imager lying outside the cover.

3. A display according to claim 1, wherein said adjustment arrangement comprises a rail and slide arrangement.

4. A display according to claim 3, wherein said rail is carried by said first element and said slide is carried by said second element.

5. A display according to claim 4, wherein said slide is substantially parallel to the longitudinal axis of the imager.

6. A display according to claim 1, wherein said shaft is also secured to said optical light beam generator system and is disposed close thereto.

7. A display according to claim 1, wherein said axis of rotation intersects said main ray inside the imager.

8. A display according to claim 3, wherein said locking means is constituted by a thrust element carried by said second element and designed to push a locking jaw.

9. A display according to claim 8, wherein said jaw comes into abutment against said rail of said first element, when said first element is in place in said slide, and said screw is tightened.

10. A display according to claim 8, wherein said jaw is caused to press against said shaft under drive from said screw.

11. A display according to claim 1, wherein said jaw is constituted by a pad formed by a section of one of the profiled edges of said slide and movable towards the longitudinal axis of said slide, and by an extension of circularly arcuate shape surrounding part of said shaft and having its free end in abutment against a part that is stationary in the direction of said movement of said pad.

12. A display according to claim 1, wherein said releasable connection arrangement is constituted by a clip-fastener arrangement.

13. A display according to claim 1, wherein said connection arrangement includes a deformable tongue provided with a locking catch.

14. A display according to claim 12, wherein said connection arrangement includes two engagement slopes associated with two guide fins.

15. A frame for a pair of eyeglasses, the frame being designed to receive a display according to claim 1 and including a cavity designed to receive said first element engaged therein.
